(19) United States
(12) Patent Application Publication
(10) Pub. No.: US 2012/0305278 A1
(43) Pub. Date: Dec. 6, 2012

(54) Hand-Held Power Tool Having Elastomer Elements for Supporting Components in the Housing

(75) Inventor: Florian Esenwein, Uhingen-Holzhausen (DE)

(73) Assignee: ROBERT BOSCH GMBH, Stuttgart (DE)

(21) Appl. No.: 13/578,221

(22) PCT Filed: Dec. 13, 2010
(86) PCT No.: PCT/EP10/69460

§ 371 Date: Aug. 9, 2012

(30) Foreign Application Priority Data
Feb. 11, 2010 (DE) 10 2010 001 793.0

(51) Int. Cl. B25F 5/00; B23Q 11/00

(52) U.S. Cl. 173/162.2; 173/170

(57) ABSTRACT

A hand-held power tool is provided which includes a drive unit in a housing, a switch device, and elastomer elements. The drive unit is configured to be switched on and off with the switch device which comprises a switch accommodated inside the housing. The elastomer elements are molded onto the outside of the housing and onto the inside of the housing and are connected to each other via an opening in a wall of the housing. An elastomer element on the inside of the housing forms an elastomer bearing configured to support the switch.

The invention relates to a portable power tool having a drive device in a housing as per the preamble of claim 1.

### PRIOR ART

DE 10 2006 020 172 A1 describes a cordless screwdriver or cordless drill which has an electric drive motor in a housing, wherein the motor housing, in which the drive motor is arranged, is adjoined by a transmission housing having a transmission, via which the motor movement is transmitted to a tool. In the joining region between the motor housing and the transmission housing there is arranged a sealing element which consists of two half-rings made of thermoplastic elastomer which is molded, next to the joining region, onto the end side of the motor housing. The half-rings also have the function of damping the transmission and sealing off the transmission space from the motor space.

Located on a handle of the housing there is a switch-on element which is connected to a switch which is arranged in the housing and via which the electric drive motor is intended to be switched on and off. Such switches inside the housing are held in their position for example via elastically deformable latching lugs. In order to be able to join the housing parts together, it is necessary to provide the switch mount in the housing with play, which must not exceed a particular degree, however, since otherwise vibrations of the power tool can lead to damage to the switch or to the connection between the switch and the motor.

### DISCLOSURE OF THE INVENTION

The invention is based on the object of increasing the operational reliability of portable power tools by way of simple measures.

This object is achieved according to the invention by way of the features of claim 1. The dependent claims specify expedient developments.

The portable power tool according to the invention has a drive device, usually an electric drive motor, downstream of which there is connected a transmission, via which the drive movement of the motor is transmitted to a tool. The portable power tool is for example an angle grinder, a cordless screwdriver or the like. In order to switch the drive device on and off, use is made of a switch device having a switch, which is arranged inside the housing and is connected to the drive motor of the drive device. When the drive motor is embodied as an electric motor, the mechanical switching movement which is initiated by the operator is converted via the switch into an electric switching movement that closes the circuit when the motor is switched on and opens the circuit when the motor is switched off. The switch is either connected to the drive motor via electric connecting cables or is flange-mounted directly onto the motor.

In the portable power tool according to the invention, elastomer elements which are connected together via an opening that is introduced into the housing wall are respectively molded on the outside and on the inside of the housing. This allows the production of the elastomer elements on the inside and outside in a single work step, in which the elastomer material is molded onto the housing from one side and can pass through the opening in the housing wall to the opposite side. In this case, the elastomer material can be molded onto the housing wall both from the inside and from the outside.

It is furthermore provided that the elastomer element located on the inside of the housing forms an elastomer bearing for supporting the switch. The supporting of the switch inside the housing on the soft material provides effective oscillation damping of the switch, and at the same time installation play for the switch can be allowed, thereby making it easier to join the housing parts together in a flush manner. The play is at least partially compensated by the soft component of the elastomer bearing, and so, in the fully fitted and assembled state, the switch is accommodated in the housing without the possibility of relative movement. At the same time, oscillations and vibrations which proceed from the drive motor or arise during workpiece machining are effectively damped or reduced, and so the risk of the switch being damaged or the connection between the switch and the drive motor or between the switch and the electric power supply being released is significantly decreased.

In addition or alternatively to increased play in the mounting of the switch inside the housing, it is also possible to allow an increased tolerance in the dimensions of the switch, since this is likewise compensated by the flexibility of the soft component in the elastomer element.

Consideration is given in particular to a thermoplastic elastomer (TPE) as the material for the elastomer element. However, embodiments made of EPDM, PU, PVC or the like are also possible.

The elastomer element on the outside of the housing, with which the elastomer bearing on the inside is configured in one piece, preferably forms a handle element, via which the portable power tool can be grasped and guided by the operator. On account of its flexibility and the increased friction, the elastomer element affords high operating comfort, and in addition the portable power tool can be held and guided safely.

In order to provide a better connection between the housing and the elastomer on the inside and outside, it may be expedient to provide elevations and/or depressions on the walls of the housing, which are encapsulated by the elastomer material. Such elevations and depressions, for example channels, improve the adhesion of the elastomer material to the housing.

The opening in the housing wall, via which the elastomer elements on the inside and the outside are connected together in one piece, is expediently filled completely with the elastomer material. The opening cross section can be round or nonround, for example oval or longitudinally directed in the form of a channel of limited length. The opening cross section is expediently matched to the flow behavior of the elastomer material, which is liquid during the injection-molding process. When the opening in the housing wall is embodied as a channel, the latter extends for example in the longitudinal direction of the housing. However, an orientation in the circumferential direction is also possible in principle.

The elastomer bearing is preferably embodied as a longitudinally directed support rib which extends on the inside of the housing. The support rib can be formed in a straight line and extend in the longitudinal direction of the housing. According to a further expedient embodiment, it is provided that the housing is embodied in multiple parts, in particular in two parts with two housing half shells, wherein an elastomer element is arranged on the inside and outside of each housing half shell. The elastomer elements on the inside of the housing form interacting elastomer bearings for the switch and are configured in a mirror-symmetrical manner with respect to one another in the assembled state of the housing half shells. If the elastomer bearings are formed as elongate support ribs, these are aligned in particular parallel to one another.

The housing, in which the switch is arranged, forms in particular a motor housing for accommodating the drive motor, wherein the motor housing is adjoined by a transmission housing having a transmission, via which the motor movement is converted into a movement of the tool of the portable power tool.

Furthermore, it is possible that, in addition to the elastomer elements on the inside or outside of the housing, further elastomer elements are molded on the housing, said further elastomer elements having further functions. Thus, it can for example be provided that a further elastomer element forms a bearing for a component of the drive device, in particular a bearing for the electric drive motor of the portable power tool. This elastomer bearing can, just like the elastomer bearing according to the invention for supporting the switch, be formed in one piece with a further elastomer element molded on the outside of the housing, said further elastomer element serving if appropriate also for improved gripping and handling of the portable power tool and/or having a sealing function in the transition region between the motor housing and the transmission housing. In the last-mentioned case, the elastomer element is located on the end side of a housing part, either on the motor housing and/or on the transmission housing, and extends at least partially over the end side of this housing.

Further advantages and expedient embodiments can be gathered from the further claims, the description of the figures and the drawings, in which:

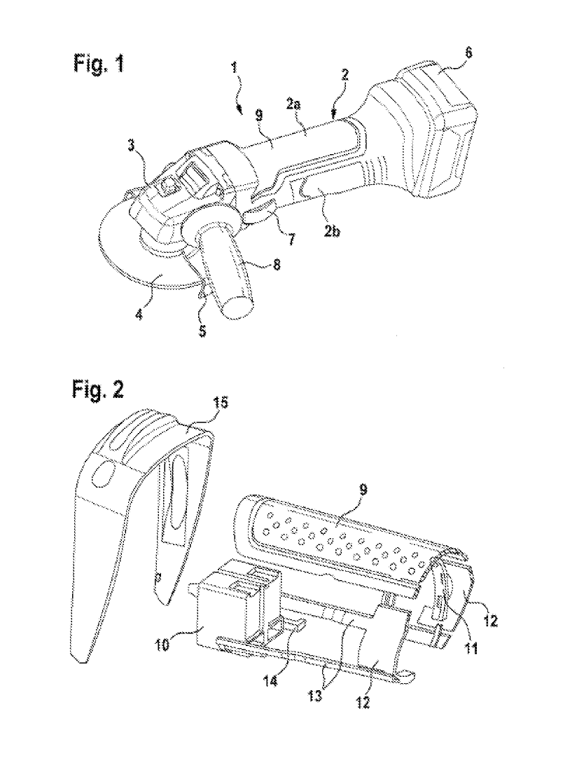

FIG. 1 shows a perspective illustration of a portable power tool configured as a cordless angle grinder,

FIG. 2 shows an exploded illustration of elastomer elements which are molded onto the outside and inside of the housing in the injection-molding process,

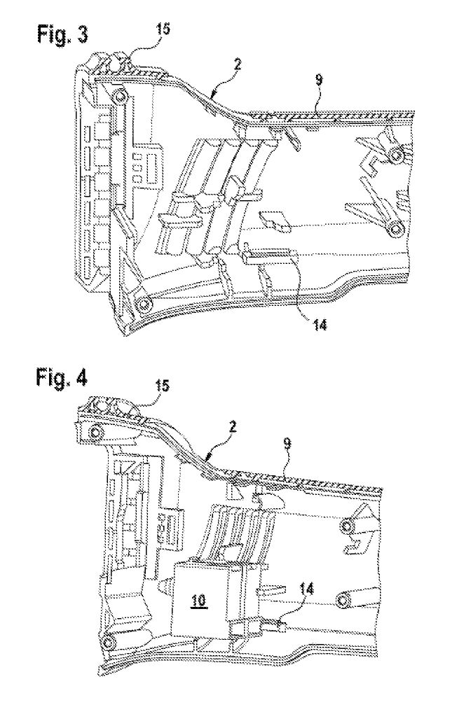

FIG. 3 shows a view of the inside of a half shell of the motor housing with a molded elastomer support rib which forms an elastomer bearing for supporting a switch for the electric drive motor,

FIG. 4 shows a similar illustration to FIG. 3, but additionally with a switch inserted,

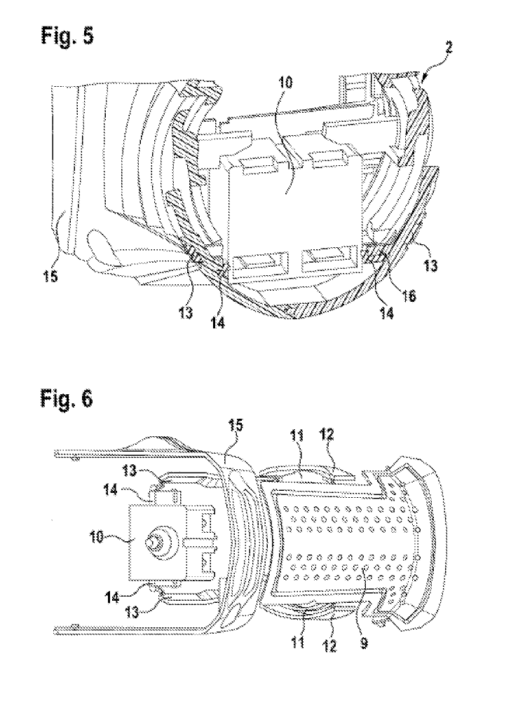

FIG. 5 shows a further view of the switch accommodated in the motor housing,

FIG. 6 shows a detail illustration of the elastomer elements including the switch,

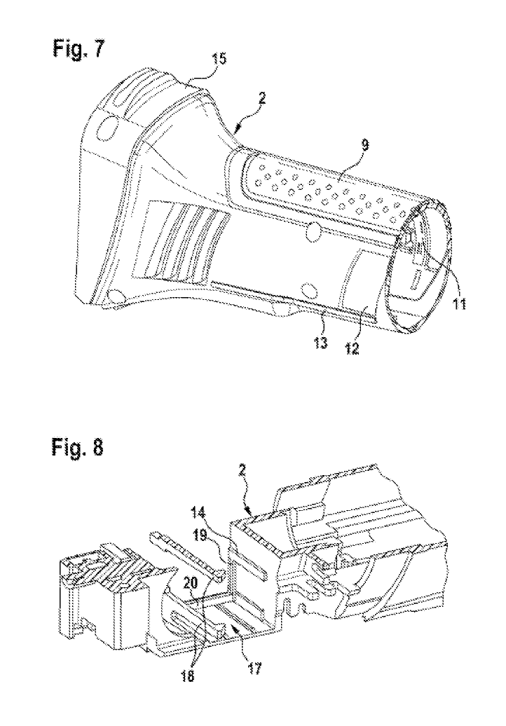

FIG. 7 shows the motor housing having the elastomer elements illustrated in FIG. 2,

FIG. 8 shows a view of the bearing mount on the inside of the housing including the elastomer bearing.

In the figures, identical components are provided with identical reference signs.

As can be gathered from the figures, the portable power tool 1 is configured as an angle grinder and has as drive device an electric drive motor in a motor housing 2 and a transmission in a transmission housing 3 which is formed separately therefrom and adjoins the motor housing. Via the drive device having the electric drive motor and the transmission, the drive movement of the motor is converted into a tool movement of the tool 4 which, in the exemplary embodiment, forms a grinding disk, which is overlapped by a protective hood 5. In order to supply electric power, a battery pack 6 which adjoins the motor housing 2 is provided in the rear part. A switch element 7 for switching the electric drive motor on and off is located in the front part, next to the transmission housing 3, of the motor housing 2. The switch element 7 projects beyond the outside of the motor housing 2 and can be actuated in an ergonomically favorable manner by the operator. The switch element 7 is connected to a switch which is located inside the motor housing 2 and via which the electric power supply to the drive motor is switched on and off. The motor housing 2 is constructed in two parts and comprises two assembled housing shells 2a and 2b. Located on the top side of the housing 2 is an elastomer element 9 which is injection-molded as a coating onto the outside of the motor housing 2.

An auxiliary handle 8 is arranged on the side of the transmission housing 3 and extends transversely to the longitudinal axis of the portable power tool.

The switch 10, which is arranged inside the motor housing and via which the electric drive motor is intended to be switched on and off, can be seen in FIGS. 2 to 6. The switch 10 is electrically connected to the drive motor and can be switched on and off via the switch element 7 (FIG. 1).

FIG. 2 also illustrates the elastomer element 9 which is injection-molded onto the outside of the motor housing. The elastomer element is formed in one piece with further elastomer elements 11 to 14, some of which extend on the outside of the housing and some on the inside of the housing, wherein elastomer elements located on opposite housing sides are connected together via openings in the housing wall of the motor housing. The elastomer element 14 forms an elastomer bearing for supporting the switch 10. Expediently, each half shell of the motor housing is assigned one or more elastomer elements on the outside of the housing and on the inside of the housing. Each housing half shell has at least one elastomer element on the outside and an elastomer bearing for supporting the switch 10.

A further, clip-like elastomer element 15 is arranged in the rear region of the housing and is axially after the switch 10. The clip-like elastomer element 15 is molded onto the outside of the motor housing in the region of the end side of the motor housing and is located in the transition between the motor housing and the battery. The elastomer element 15 serves the purpose of sealing and reducing oscillations between the motor housing and the battery.

The elastomer bearing 14 is configured as a rib which extends in the longitudinal direction and, as can be gathered from FIGS. 2 and 4, extends beyond the switch 10 in the longitudinal direction. The elastomer bearing 14 has preferably a greater axial length than the switch 10, such that not only the switch 10 can be received by the elastomer bearing 14 but in addition also a plug module, via which the electrical connection between the switch 10 and the drive motor or between the switch 10 and the power supply takes place.

As can be gathered from the sectional illustration according to FIG. 5, an inwardly extending protrusion 16, which serves to receive and support the elastomer bearing 14, is formed in one piece with the wall of the housing 2 on the inside of the housing. The forces that arise in operation and originate from the switch 10 or the oscillations of the portable power tool are directed to the protrusion 16 via the elastomer bearing 14.

FIG. 8 illustrates the mount 17 in the housing 2 for the switch. Elastically held latching members 18, which laterally bound the mount 17 and secure the inserted switch in the mount 17 with a latching fit, are configured in one piece with the housing 2.

As can further be gathered from FIG. 8, a first and a second elastomer rib 19 and 20, which are in each case at right angles to one another and extend along the side walls of the mount 17, are formed in one piece with the elastomer bearing 14. Abutments on the housing are softly cushioned in the mount 17 via the various sections of the elastomer bearing 14 and/or of the elastomer ribs 19 and 20, in order to softly support the inserted switch in a corresponding manner.

It may be expedient to arrange a further elastomer element which is arranged on the inside of the housing and is formed in one piece with an elastomer element on the outside of the housing and forms a bearing for a component of the drive device, in particular a bearing for the drive motor. If appropriate, both the elastomer bearing for the switch and the elastomer bearing for the drive motor are configured in one piece with the same elastomer element on the outside of the housing.

1. A portable power tool comprising:
a housing having a housing wall, with an outside and an inside, and an opening formed in the housing wall between the outside and the inside;
a drive device located in the housing;
a switch device having a switch, said switch device configured to switch on and off the drive device, the switch arranged inside the housing; and
a plurality of elastomer elements molded on the outside and on the inside of the housing and connected together through the opening in the housing wall, wherein at least one of the plurality of elastomer elements is located on the inside of the housing and forms an elastomer bearing configured to support the switch.

2. The portable power tool of claim 1, wherein at least one of the plurality of elastomer elements is located on the outside of the housing and forms a handle element.

3. The portable power tool of claim 1, wherein the elastomer bearing is a longitudinally oriented support rib.

4. The portable power tool of claim 1, wherein the elastomer bearing projects beyond at least one side wall of the switch.

5. The portable power tool of claim 1, wherein:
the housing comprises two housing half shells each having an inside and an outside; and
the plurality of elastomer elements are located on the inside and outside of each housing half shell.

6. The portable power tool of claim 5, wherein the elastomer bearing comprises a plurality of elastomer bearings arranged in a mirror-symmetrical manner with respect to one another on the inside of the housing half shells.

7. The portable power tool a of claim 1, wherein the opening in the housing wall is a channel having a longitudinal length and a transverse length, and the longitudinal length is greater than the transverse length.

8. The portable power tool of claim 1, wherein the elastomer bearing is arranged on the housing and is configured to accommodate a drive motor.

9. The portable power tool of claim 1 further comprising:
a separately formed damping element arranged on the inside of the housing and configured to support the switch.

10. The portable power tool of claim 1 further comprising:
a further elastomer element arranged on the inside of the housing and formed in one piece with at least one of the plurality of elastomer elements on the outside of the housing, wherein the further elastomer element forms a bearing for a component of the drive device.
